(19) United States
(12) Patent Application Publication
(10) Pub. No.: US 2011/0273256 A1
(43) Pub. Date: Nov. 10, 2011

(54) MODULAR RING-SHAPED CORE

(75) Inventors: Charles W. JOHNSON, Bland, VA (US); Jan Leander, Shanghai (CN); Karel Bilek, Forestlake (AU); Benjamin Weber, Winterberg (DE)

(73) Assignee: ABB TECHNOLOGY AG, Zurich (CH)

(21) Appl. No.: 12/945,326

(22) Filed: Nov. 12, 2010

Related U.S. Application Data
(63) Continuation of application No. PCT/EP2008/003826, filed on May 13, 2008.

(51) Int. Cl. H01F 27/245

(52) U.S. Cl. 336/170

(57) ABSTRACT

The disclosure relates to a ring-shaped core for a power transformer. The ring-shaped core extends about an imaginary center axis in the form of a closed toroidal structure and is constituted of a plurality of adjacent layers of sheet metal. The ring-shaped core, along the length of the toroidal structure, is constituted of at least three core section modules that can be connected to and detached from each other, the core section modules being interconnected by an overlap of individual sheet layers and/or sheet layer sections. The disclosure also relates to the arrangement of ring-shaped cores having winding modules. The latter can be arranged in a common connecting structure and every ring core having winding modules arranged therein can be separately introduced into the connecting structure and removed therefrom in a non-destructive manner.

### RELATED APPLICATION(S)

This application claims priority as a continuation application under 35 U.S.C. §120 to PCT/EP2008/003826 filed as an International application on May 13, 2008 designating the U.S., the entire content of this application is hereby incorporated by reference in its entirety.

### FIELD

The disclosure relates to a ring-shaped core for a power transformer, such as a transformer having a ring-shaped core extending as a closed toroidal structure around an imaginary central-axis, and having a number of mutually adjoining layers of laminate. The disclosure also relates to an arrangement of plural ring-shaped cores with winding modules.

### BACKGROUND INFORMATION

It is known to use transformers in the distribution of electrical energy by AC voltage being transformed from a high level to a low voltage level, or vice versa. Energy distribution systems can be designed to be three-phase systems (e.g., voltages which are respectively shifted through a phase angle of 120° and which, when summated mathematically in-phase, can result in a value zero in a symmetrical state of an energy distribution system being applied to three mutually associated individual conductors). The power ranges of such power transformers can range from, for example, a few kVA up to several 100 MVA, and the operating voltages can be between, for example, 6 kV and 380 kV.

A three-phase power transformer can have, at least in each case, one primary and one secondary winding for each phase, with the result that there can be at least 6 individual windings in total. Three-phase power transformers are known in which all of the windings can be arranged around a common transformer core with a plurality of limbs, wherein in each case one primary and one secondary winding of a phase is then wound around a limb, for example.

Three-phase power transformers are also known which can be formed by three single-phase transformers being interconnected electrically in a suitable manner, in which the primary and secondary winding of, in each case, one phase are, in each case, wound around a separate ring-shaped transformer core.

In the case of such a single-phase winding arrangement with a ring-shaped core, it can be desirable for reasons of compactness of the arrangement to arrange the single-phase primary and/or secondary winding as a plurality of separate winding segments, for example along a path resembling a circle, wherein the ring-shaped core passes through all of the winding segments. See, for example, European patent specification EP 0 557 549 B1.

Such an arrangement does not permit modular replacement of winding segments of such a ready-assembled transformer without further winding segments likewise needing to be removed at least temporarily from the transformer core.

### SUMMARY

A ring-shaped core for a power transformer is disclosed, including at least three core section modules, extending as a closed toroidal structure around an imaginary central-axis; a plurality of mutually adjoining layers of laminate, the at least three core section modules connected releasably to one another; and a connection of the core section modules for meshing of at least one of individual laminate layers and laminate layer regions.

A power transformer is disclosed including a ring shaped core, the ring-shaped core having at least three core section modules extending as a closed toroidal structure around an imaginary central-axis; a plurality of mutually adjoining layers of laminate, the at least three core section modules connected releasably to one another; and a connection of the core section modules for meshing of at least one of individual laminate layers and laminate layer regions.

### BRIEF DESCRIPTION OF THE DRAWINGS

The disclosure and exemplary embodiments are described in more detail with reference to the drawings, in which:

FIG. 1 shows an exemplary embodiment of a first core section module with associated winding module;

FIG. 2 shows an exemplary embodiment of a ring-shaped core with winding modules; and

FIG. 3 shows an arrangement of exemplary ring-shaped cores with winding modules.

### DETAILED DESCRIPTION

The disclosure relates to reducing the complexity involved with replacement of a winding segment for a power transformer with a ring-shaped transformer core and a plurality of winding segments for the ring-shaped core.

According to an exemplary embodiment, a ring-shaped core can be formed along a toroidal structure from at least three core section modules which can be connected to one another and released from one another, and the connection of the core section modules can be provided by meshing or overlapping of individual laminate layers or laminate layer regions.

The modular design of an exemplary ring-shaped core, according to an exemplary embodiment of the disclosure, from at least three core section modules which can be structurally identical and can also be released from one another, makes it possible to selectively disassemble the individual transformer components, such as winding modules or winding segments, which can be arranged along the ring-shaped core and through which the ring-shaped core passes. The complexity in terms of maintenance involved when replacing a winding module can thereby be reduced.

The releasable connection of the individual core section modules can be provided according to the disclosure by meshing and/or overlapping of a plurality of laminate layers or laminate layer regions between mutually adjacent core sections. Thus, a magnetic flux can be guided to a sufficient extent in the transition region between mutually adjoining core sections.

In a further exemplary embodiment of the ring-shaped core according to the disclosure, at least sections of the ring-shaped core can have a core cross section which can be substantially an ellipse or circle. This is possible, for example, as a result of a stratification of the core from a plurality of laminate stack layers, with in each case, a different rectangular cross section per laminate stack layer.

In an exemplary embodiment of the ring-shaped core according to the disclosure, one winding module with, in each case, at least one electrical winding can be associated with each core section module.

The winding module and core section module can then be removed easily and jointly in the event of a fault without a further winding module, which is not defective, needing to be removed from the ring-shaped core. All of the winding and core section modules can have an identical design. These results can be realized in both a circular ring-shaped core and for a polygonal ring-shaped core, for example, with 3, 4, 5, 6, 7, 8, 9, 10, 11 or 12 corners.

In accordance with an exemplary embodiment of the ring-shaped core according to the disclosure, at least two DC-isolated electrical windings can be arranged in a winding module.

This makes it possible, for example, to jointly arrange part of a primary winding and a secondary winding of a power transformer within one winding module. The manufacturing complexity can be reduced as a result.

By casting such a winding module with a suitable insulating material, for example, based on epoxy resin, the susceptibility of the winding module to faults can also be reduced because, in this case, it can be protected from mechanical influences. In addition, the use of an insulating material can make it possible to reduce the insulating gap between adjacently arranged winding modules.

In one exemplary embodiment of the ring-shaped core according to the disclosure, a core section module can be connected in a force-fitting and/or form-fitting manner to the respectively associated winding module, with the result that a transformer module can be produced.

Jointly disassembling and subsequently assembling a corresponding replacement transformer module, for example, a replacement core section module with a replacement winding module, can thus be simplified.

In accordance with an exemplary embodiment of a ring-shaped core with associated winding modules, the winding modules can be coupled to one another electrically. Provision can also be made for electrical terminals which can be common to groups of electrically coupled winding modules to be passed out.

By virtue of such suitable electrical coupling, for example, by virtue of windings of a plurality of winding modules being connected in series and/or parallel, it can be possible to achieve the functionality of a single-phase power transformer which can be coupled to an electrical energy supply system at the common terminals.

In an exemplary embodiment of ring-shaped cores with winding modules the respective ring-shaped cores with winding modules can be arranged in a common connecting structure and can be introduced into the connecting structure separately and removed therefrom without being destroyed.

A connecting structure can be understood to refer to an apparatus by which at least two ring-shaped cores with winding modules or two complete ring-shaped core transformers can be connected to one another mechanically. Furthermore, such a connecting structure can also have electrical conductors and parts of electrical coupling apparatuses, for example, plugs, sockets or clamp-type terminals, which can be used to connect the windings or winding modules of one or more ring-shaped core transformers. The electrical terminals of a winding or a winding module expediently have a corresponding mating piece of the coupling apparatus.

Energy distribution systems can be designed to be three-phase. The functionality of an arrangement including a ring-shaped core according to the disclosure with associated windings which are electrically interconnected in a suitable manner corresponds to the functionality of a single-phase power transformer. In order to achieve the functionality of a three-phase power transformer, an arrangement and the electrical interconnection of three single-phase transformers can be suitable, which also represents an exemplary embodiment of the arrangement according to the disclosure.

According to an exemplary embodiment of the disclosure, a likewise modular arrangement of three ring-shaped cores which can be designed in module fashion in accordance with the disclosure, with connected winding modules can be provided in a common connecting structure (as discussed herein). The complexity involved with replacing a single defective winding module of such an interconnected arrangement of a plurality of single-phase transformers can thus be further simplified.

In an exemplary embodiment of the arrangement according to the disclosure, the connecting structure can have apparatuses for electrically coupling individual winding modules and/or common electrical terminals of the winding modules. Such an electrical connection can be realized, for example, via a plug-type connection. The connection of such an arrangement to an energy supply system can thereby be simplified.

In accordance with an exemplary embodiment according to the disclosure, at least two ring-shaped cores with winding modules can be arranged axially along a common central-axis or else on a common plane transversely with respect to the respective central-axis. The construction of the common connecting structure can be thereby simplified and the amount of space involved can be reduced.

In an exemplary embodiment of a ring-shaped core according to the disclosure or exemplary embodiments of arrangements of such ring-shaped cores according to the disclosure, the ring-shaped core can have 3, 4, 5, 6, 7, 8, 9, 10, 11 or 12 core section modules.

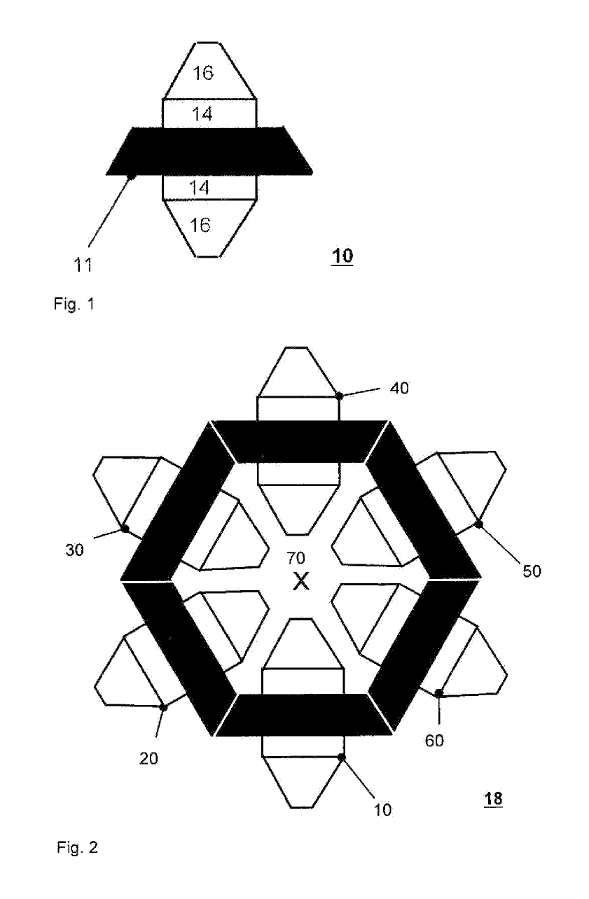

FIG. 1 shows a first transformer module 10 with a first core section module 11 with associated winding module, the winding module having a first electrical winding 14 and a second electrical winding 16, which are wound around a winding axis. The core section module and the winding module can be connected to one another mechanically to form a transformer module, with the result that the transformer module can be lifted or moved as one component part.

A plurality of transformer modules 10 which can have a substantially identical design can be used as the starting basis for a modular transformer core. The substantially identical design of the transformer modules can be useful for the respective transformer modules to be capable of being replaced with one another. For geometric reasons, depending on the given boundary conditions such as transformation ratio of the transformer, voltage level etc., for example, a number of 3, 4, 5, 6, 7, 8, 9, 10, 11 or 12 core section modules per ring-shaped core can be suitable. According to the disclosure, at least three core section modules can be specified, but a greater number than 12 can be increasingly unfavorable from a design point of view since the respective winding modules would be correspondingly narrower and would therefore result in increased complexity in manufacture. In addition, the manufacturing complexity also increases with an excessively high number of core section or winding modules.

FIG. 2 shows a hexagonal ring-shaped core with six transformer modules 10, 20, 30, 40, 50, 60, which can be arranged on a circular path around a central-axis 70. The transformer module 10 shown in FIG. 1 and the five other transformer modules 20, 30, 40, 50, 60 with a substantially identical design are a useful part of the ring-shaped core with winding modules illustrated.

Each core section module 11 can be connected to further core section modules which are adjoining on both sides by a suitable connection, for example, intermeshing in each case between adjacent laminate stacks forming the core section modules. Such meshing can improve the guidance of the magnetic flux along the extent of the ring-shaped core, for example, in the connection regions. Furthermore, further connecting mechanisms can be provided which can increase the mechanical strength of the connection between adjacent core section modules, for example, a screw-type connection through the meshing region between adjacent core section modules.

The gaps shown in FIG. 2 between the respective core section modules are only intended to be a graphical representation of the boundary area between adjacent core section modules. In an actual arrangement, such a gap is not provided, and, in addition, the laminates which form the ring-shaped core in its essence mesh with one another in the boundary regions.

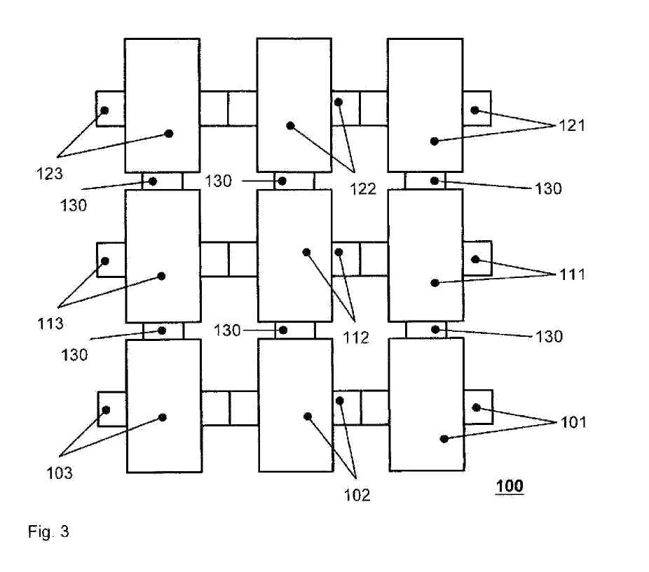

FIG. 3 shows an exemplary arrangement 100 of three ring-shaped cores or ring-shaped core transformers in a side view. In this example, each ring-shaped transformer has in each case six transformer modules, of which only in each case three are shown in this perspective view from the side. Each of the transformer modules 101, 102, 103, 111, 112, 113, 121, 122, 123 illustrated can have in each case one core section module with an identical design and one winding module, similar to the transformer module shown in FIG. 1.

The transformer modules 101, 102, 103 in FIG. 3 are the visible part of a first ring-shaped core transformer, which is primarily formed from these three transformer modules and three further transformer modules which should be imagined to be located in the rear region. Similarly, the transformer modules 111, 112, 113 in this illustration are the visible part of a second ring-shaped core transformer and the transformer modules 121, 122, 123 in FIG. 3 are the visible part of a third ring-shaped core transformer.

All three ring-shaped core transformers can be arranged along a common central-axis (not illustrated) vertically one above the other.

Insulating blocks 130, which can remove the downward load of the ring-shaped core transformers, can be arranged between the ring-shaped core transformers. The insulating blocks 130 can have an electrically insulating capacity and in addition have vibration-damping properties. The insulating blocks 130 can be considered to be part of a common connecting structure of the three ring-shaped core transformers. In this way, the operating noise of such an arrangement can also be reduced.

In the event that a defective transformer module, for example, the transformer module 112, is replaced, the third ring-shaped core transformer can be raised slightly with a first mobile lifting device and the second ring-shaped core transformer can be removed from the connecting structure with a second mobile lifting device. It can be desirable here to release the electrical connections of the second ring-shaped core transformer, which can be in the form of easily releasable connections such as a plug-type connection, for example. It can also be desirable to release the electrical connections between the transformer module 112 to be replaced and the other transformer modules in the same ring-shaped core transformer.

The relevant transformer module 112 can be removed from the ring-shaped core. The ring-shaped core should be located in a safe deposited position during this process so that the separated part of the ring-shaped core 111, 113 is not damaged mechanically.

Then, a replacement transformer module with a substantially identical design can be inserted into the separated ring-shaped core and the electrical connections between the replacement transformer module and the other modules in the second ring-shaped core can be produced. Subsequently, the second ring-shaped core transformer needs to be brought back into the original position within the connecting structure, the electrical connections to the first and third ring-shaped core transformer can be produced again and the third ring-shaped core transformer can be placed on to the insulating blocks 130 with the first mobile lifting device.

An exemplary embodiment according to the disclosure of a connecting structure for a plurality of modular ring-shaped core transformers can include a shelf-like storage device with a plurality of planes one above the other. A ring-shaped core transformer can be positioned in each plane and can be connected electrically and mechanically thereto. A lifting operation of further ring-shaped core transformers located above that ring-shaped core transformer with a transformer module to be replaced is not necessary. In further configurations of a connecting structure according to the disclosure, the planes of the shelf-like storage device on which a ring-shaped core can be positioned can be moved out of the storage device with the aid of telescopic rails. The removal operation of a ring-shaped core transformer can thus be further simplified.

Thus, it will be appreciated by those having ordinary skill in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A ring-shaped core for a power transformer, comprising:
at least three core section modules extending as a closed toroidal structure around an imaginary central-axis;
a plurality of mutually adjoining layers of laminate, the at least three core section modules connected releasably to one another; and
a connection of the core section modules for meshing of at least one of individual laminate layers and laminate layer regions.

2. The ring-shaped core as claimed in claim 1, wherein at least sections of the ring-shaped core have a core cross section which is substantially an ellipse or circle.

3. The ring-shaped core as claimed in claim 1, comprising:
at least one winding module with, in each case, at least one electrical winding associated with each core section module.

4. The ring-shaped core as claimed in claim 3, comprising:
at least two DC-isolated electrical windings arranged in a winding module.

5. The ring-shaped core as claimed in claim 3, wherein a core section module is connected in at least one of force-fitting and form-fitting manner to a respective associated winding module to form a transformer module.

6. The ring-shaped core as claimed in claim 3, comprising:
plural winding modules coupled to one another electrically.

7. The ring-shaped core as claimed in claim 6, comprising:
electrical terminals which are common to all of the winding modules and are passed out.

8. The ring-shaped core as claimed in claim 3, in combination with another ring-shaped core to form an arrangement wherein the ring-shaped cores are arranged in a common connecting structure, and each ring-shaped core is arranged with a winding module and is introduced separately into the connecting structure for removal therefrom without damage.

9. The ring-shaped core as claimed in claim 8, wherein the connecting structure comprises:
apparatuses for electrically coupling at least one individual winding module and common electrical terminals of the winding modules.

10. The ring-shaped core as claimed in claim 8, wherein the ring-shaped cores with winding modules are interconnected using the connecting structure to form an electrical function group of a three-phase power transformer.

11. The ring-shaped core as claimed in claim 8, wherein at least two ring-shaped cores with winding modules are arranged axially along a mid-axis.

12. The ring-shaped core as claimed in claim 8, wherein at least two ring-shaped cores with winding modules are arranged on a common plane transversely with respect to the central-axis.

13. The ring-shaped core as claimed in claim 8, comprising:
electrical terminals which are common to at least two ring-shaped cores with winding modules are passed out at the connecting structure.

14. The ring-shaped core as claimed in claim 1, wherein a number of core section modules per ring-shaped core is 3, 4, 5, 6, 7, 8, 9, 10, 11 or 12.

15. The ring-shaped core as claimed in claim 2, comprising:
a winding module with, in each case, at least one electrical winding associated with each core section module.

16. The ring-shaped core as claimed in claim 4, wherein a core section module is connected in at least one of force-fitting and form-fitting manner to a respective associated winding module to form a transformer module.

17. The ring-shaped core as claimed in claim 4, comprising:
plural winding modules coupled to one another electrically.

18. The ring-shaped core as claimed in claim 5, comprising:
plural winding modules coupled to one another electrically.

19. The ring-shaped core as claimed in claim 4, in combination with another ring-shaped core, to form an arrangement wherein the ring-shaped cores are arranged in a common connecting structure, and each ring-shaped core is arranged with a winding module and is introduced separately into the connecting structure for removal therefrom without damage.

20. A power transformer, comprising:
a ring shaped core, the ring-shaped core comprising at least three core section modules extending as a closed toroidal structure around an imaginary central-axis;
a plurality of mutually adjoining layers of laminate, the at least three core section modules connected releasably to one another; and
a connection of the core section modules for meshing of at least one of individual laminate layers and laminate layer regions.
